(19) United States
(12) Patent Application Publication
(10) Pub. No.: US 2006/0254250 A1
(43) Pub. Date: Nov. 16, 2006

(54) Drain tube for a low-pressure shaft of a turbomachine

(75) Inventors: Bruno Dambrine, Le Chatelet en Brie (FR); Aymeric Hugonie, Cheptainville (FR); Claude Mons, Savigny le Temple (FR); Jean-Luc Soupizon, Vaux le Penil (FR)

Correspondence Address: CONNOLLY BOVE LODGE & HUTZ LLP;(FOR CABINET BEAU DE LOMENIE CASES), P.O. BOX 2207, WILMINGTON, DE, 19899-2207, US

(73) Assignee: Snecma Moteurs, Paris (FR)

(21) Appl. No.: 11/168,929

(22) Filed: Jun. 29, 2005

(30) Foreign Application Priority Data
Jun. 29, 2004 (FR) 04 07139

(51) Int. Cl. F02C 7/06

(52) U.S. Cl. 60/39.08

(57) ABSTRACT

The invention provides a drain tube for mounting coaxially inside a low-pressure shaft of a turbomachine, the tube comprising a hollow metal tubular portion of length substantially identical to that of the shaft inside which said tube is to be mounted, the outside surface of the metal portion of the tube being covered over at least a fraction of its length in a composite material based on fibers oriented along a direction that is substantially longitudinal so as to confer bending strength to the tube.

### BACKGROUND OF THE INVENTION

The present invention relates to the general field of drain tubes for mounting inside the low-pressure shaft of a turbomachine.

In a turbomachine, the shaft of the low-pressure spool, referred to below as the low-pressure shaft, drives rotation of the fan shaft at its upstream end. This fan shaft is supported to rotate in a rolling bearing which needs to be lubricated and cooled. For this purpose, oil is injected between the rings of the rolling bearing by a feed circuit. The oil is confined in an enclosure in which it mixes with air prior to being exhausted to the exhaust casing of the turbomachine by flowing inside the low-pressure shaft.

In order to ensure that the oil flowing inside the low-pressure shaft does not damage the low-pressure shaft, particularly by coking thereon, it is known to mount a hollow oil-removal tube concentrically inside the shaft, which tube is referred to herein as a drain tube. Drain tubes must satisfy certain criteria: in particular they must be light in weight, proof against oil, and present good capacity to deform in bending so as to prevent them from snapping apart in the event of a breakdown.

In order to satisfy those criteria, proposals have been made to make drain tubes out of metal, e.g. out of titanium or nickel. Such tubes present good buckling capacity serving to avoid them snapping in the event of a breakdown. The main problem lies in the modulus/density ratio of the metal which requires intermediate fastener supports to be installed between the low-pressure shaft and the tube in order to prevent any radial displacement of the tube inside the shaft while the shaft is rotating. Such support makes mounting and removing the tube inside the shaft difficult since those operations are performed blind, and in the event of the tube being wrongly positioned inside the shaft, cracks appear in the shaft.

### OBJECT AND SUMMARY OF THE INVENTION

A main object of the present invention is thus to mitigate such drawbacks by proposing a drain tube that enables the intermediate supports to be omitted while conserving oil-tightness and good capacity to deform in bending.

To this end, the invention provides a drain tube for mounting coaxially inside a low-pressure shaft of a turbomachine, the tube comprising a hollow metal tubular portion of length substantially identical to that of the shaft inside which said tube is to be mounted, wherein the outside surface of the metal portion of the tube is covered over at least a fraction of its length in a composite material based on fibers oriented along a direction that is substantially longitudinal so as to confer bending strength to the tube.

The presence of composite material fibers oriented along the longitudinal direction of the tube gives it good bending deformation capacity while the shaft is rotating by significantly increasing its modulus. The drain tube thus has no intermediate support fastening it to the shaft, thus making it easier to mount and dismount into and from the shaft. Leaktightness of the tube is also conserved.

Preferably, the composite material covering the outside surface of the metal portion further includes braided fibers for holding the longitudinal fibers in place.

The metal portion may be provided at an upstream end with a fastener endpiece for fastening to an upstream end of the shaft in which the tube is to be mounted. Under such circumstances, the fastener endpiece may include a device for preventing rotation relative to the shaft. The endpiece may also include at least one sealing gasket co-operating with the shaft so as to prevent oil from propagating between the shaft and the drain tube.

Preferably, the metal portion of the drain tube is made of titanium and the composite material is made of resin-impregnated carbon fibers. Such longitudinal carbon fibers may cover 50% to 75% of the outside surface of the metal portion.

The present invention also provides a low-pressure shaft for a turbomachine including a drain tube as defined above.

### BRIEF DESCRIPTION OF THE DRAWING

Other characteristics and advantages of the present invention appear from the following description made with reference to the accompanying drawing which show an embodiment having no limiting character. In the figures:

FIG. 1 is a fragmentary longitudinal section view of the upstream portion of a drain tube of the invention mounted inside a low-pressure shaft of a turbomachine; and

FIG. 2 is a fragmentary longitudinal section view of the downstream portion of the FIG. 1 drain tube.

### DETAILED DESCRIPTION OF AN EMBODIMENT

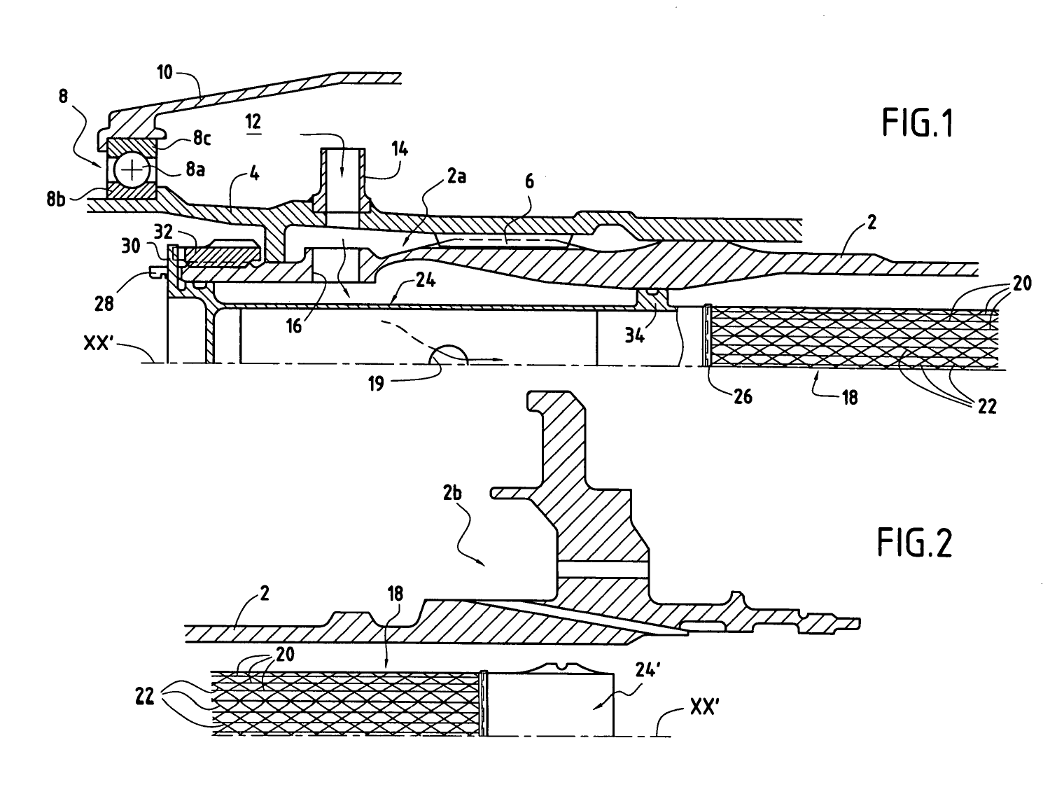

As shown in FIG. 1, reference 2 designates part of a low-pressure shaft of a turbomachine. This shaft 2 of longitudinal axis XX′ is hollow and extends along practically the entire length of the turbomachine. At its upstream end 2a, it drives rotation of the fan shaft 4 via fluting 6. The fan shaft 4 is disposed coaxially around the low-pressure shaft 2.

Moving fan blades (not shown) are fastened to the upstream end of the fan shaft 4. The fan shaft 4 is also supported to rotate by a rolling bearing 8. This bearing 8 is made up, for example, of balls 8a inserted between an inner ring 8b mounted on the fan shaft 4 and an outer ring 8c mounted on a shaft 10.

An oil feed circuit (not shown) serves to convey and inject oil between the rings 8b, 8c of the rolling bearing 8 in order to lubricate and cool it. The lubrication and cooling oil is confined in an oil enclosure 12 defined in particular by the fan shaft 4 and the shaft 10 to which the outer ring 8c of the bearing 8 is mounted.

In the oil enclosure 12, the fan shaft is pierced by a plurality of hollow bushings 14 (or chimneys) which serve to evacuate the lubricating and cooling oil away from the enclosure 12. A plurality of holes 16 are formed facing the hollow bushings 14 in the upstream end 2a of the low-pressure shaft 2 so as to convey the lubricating and cooling oil towards the inside of the low-pressure shaft.

In the invention, provision is made to mount a drain tube 18 coaxially inside the low-pressure shaft 2 for the purpose of draining away the lubricating and cooling oil without damaging the low-pressure shaft.

Such a tube 18 is in the form of a hollow metal tubular part centered on the axis XX′ and having substantially identical length to the low-pressure shaft 2. The drain tube 18 thus extends from the upstream end 2a of the low-pressure shaft 2 (FIG. 1) to the downstream end 2b thereof (FIG. 2).

Furthermore, the drain tube 18 has a plurality of openings 19 formed through its upstream end in order to enable the oil to be drained into the inside of the tube.

In accordance with the invention, the outside surface of the metal portion of the tube 18 is covered over at least a fraction of its length in a composite material based on fibers 20 that are oriented in a substantially longitudinal direction (i.e. parallel to the axis XX′ of the tube) so as to confer bending strength on the tube.

In FIGS. 1 and 2, the longitudinal fibers 20 cover practically the entire length of the drain tube 18. Nevertheless, it would also be possible for them to cover only a fraction of the metal portion of the tube, either continuously or discontinuously.

Thus, the drain tube 18 presents a modulus/density ratio that is suitable for making it unnecessary to use intermediate fastener supports between the low-pressure shaft 2 and the tube, while nevertheless maintaining the oil-tightness and the plastic deformation capacity of the tube. The weight of the drain tube should also be as small as possible.

According to an advantageous characteristic of the invention, the composite material further comprises braided fibers 22 for holding the longitudinal fibers 20 on the metal portion of the tube 18. These braided fibers 22 overlie the longitudinal fibers 20 and present an inclination lying in the range 45° to 60° relative to the axis XX′ of the tube, for example.

Preferably, the metal portion of the drain tube 18 is made of titanium and the composite material is made of resin-impregnated carbon fibers 20 and 22. The use of carbon fibers provides a composite material that enables the best bending strength to be conferred on the tube. Carbon fibers are also in widespread use in the industry which makes them less expensive than other composite materials.

Naturally, other materials could be use for making the longitudinal fibers and the braided fibers of the drain tube. Similarly, the metal portion of the drain tube may be obtained using other metals, such as nickel, for example.

The longitudinal carbon fibers 20 may cover 50% to 75% and preferably about 60% of the outside surface of the metal portion of the drain tube 18.

In the embodiment of the tube shown in FIGS. 1 and 2, the metal portion of the drain tube 18 is provided at its upstream end with a fastener endpiece 24 for fastening to the upstream end 2a of the low-pressure shaft 2. Such a fastener endpiece 24 is also made of metal (e.g. of titanium like the tubular portion of the tube) and can thus be fastened to the upstream end of the metal tube by welding 26.

It should be observed that the openings 19 that allow oil to be drained into the inside of the drain tube 18 are preferably formed through the fastener endpiece 24. It should also be observed that the downstream end of the metal portion of the drain tube 18 may also be provided with an endpiece 24′ (FIG. 2). Such a downstream endpiece 24′ serves mainly to support the drain tube and to protect the low-pressure shaft in the event of the oil mist catching fire.

According to an advantageous characteristic of the invention, the fastener endpiece 24 includes an antirotation device engaging the low-pressure shaft 2. The antirotation device may, for example, be in the form of a finger 28 of the low-pressure shaft 2 being received in a shoulder 30 on the fastener endpiece 24, thus preventing any relative rotation between the tube and the low-pressure shaft.

A fastener nut 32 for clamping on the low-pressure tube 2 at its upstream end 2a so as to co-operate with the shoulder 30 of the fastener endpiece 24 serves to hold the drain tube 18 in the shaft 2. It should be observed that the drain tube 18 is mounted inside and dismounted from the low-pressure shaft 2 from the front, i.e. from the upstream end 2a of the shaft 2.

According to another advantageous characteristic of the invention, the fastener endpiece 24 includes at least one sealing gasket 34 co-operating with the low-pressure shaft 2. This sealing gasket 34 is disposed downstream from the oil draining openings 19. It serves to prevent oil coming from the enclosure 12 flowing in the annular space defined between the low-pressure shaft 2 and the drain tube 18.

It is also possible to protect the fibers of the drain tube against the harmful effects of oil by covering them in a protective film of the Viton® type. The protective film is not shown in the figures.

The method of fabricating the drain tube of the invention stems in obvious manner from the above description.

The metal portion of the drain tube remains identical to that of drain tubes known in the prior art, except that intermediate fastener supports are omitted. The endpieces 24 and 24′ are welded to the upstream and downstream ends of the metal portion. The longitudinal fibers 20 and the braided fibers 22 are deposited using a method that is known in the composite materials field: after being placed on the outside surface of the metal portion, the fibers are impregnated with resin (e.g. epoxy resin), and then polymerized.

More particularly, the fibers 22 for holding the longitudinal fibers 20 may be braided directly onto the metal portion of the tube using a bobbin, or they may be braided in preparation in the form of a sleeve which is then fitted over the metal portion of the tube.

What is claimed is:

1. A drain tube for mounting coaxially inside a low-pressure shaft of a turbomachine, the tube comprising a hollow metal tubular portion of length substantially identical to that of the shaft inside which said tube is to be mounted, wherein the outside surface of the metal portion of the tube is covered over at least a fraction of its length in a composite material based on fibers oriented along a direction that is substantially longitudinal so as to confer bending strength to the tube.

2. A tube according to claim 1, in which the composite material further comprises braided fibers for holding the longitudinal fibers.

3. A tube according to claim 1, in which the metal portion is provided at an upstream end with a fastener endpiece for fastening to an upstream end of the shaft inside which said tube is to be mounted.

4. A tube according to claim 3, in which the fastener endpiece includes an antirotation device for co-operation with the shaft in which said tube is to be mounted.

5. A tube according to claim 3, in which the fastener endpiece includes at least one sealing gasket for co-operating with the shaft in which said tube is to be mounted.

6. A tube according to claim 1, in which the metal portion is made of titanium.

7. A tube according to claim 1, in which the composite material is made of resin-impregnated carbon fibers.

8. A tube according to claim 7, in which the longitudinal carbon fibers cover 50% to 75% of the outside surface of the metal portion.

9. A low-pressure turbomachine shaft, including a drain tube according to claim 1.
